(19) United States
(12) Patent Application Publication
(10) Pub. No.: US 2012/0049528 A1
(43) Pub. Date: Mar. 1, 2012

(54) Energy Converting System

(76) Inventor: Kuo-Yuan Lynn, Tainan City (TW)

(21) Appl. No.: 12/872,821

(22) Filed: Aug. 31, 2010

(51) Int. Cl. F03D 9/00

(52) U.S. Cl. 290/55

(57) ABSTRACT

An energy converting system for converting wind energy into kinetic energy has at least one energy converting mechanism that includes a fixed shaft unit including an upright fixed shaft, a windmill device, an air compartment, and a purifying device. The windmill device includes a windmill unit disposed rotatably around the fixed shaft and including at least two first blades driven by the wind energy. The air compartment is disposed above the windmill device. Rotation of the first blades of the windmill unit results in upward flow of compressed air into the air compartment to thereby allow the solar-heated air to be jetted out of the air compartment in such a manner to rotate the windmill device about the fixed shaft. The purifying device is disposed in the air compartment for filtering out impurities in air before the air flows out of the air compartment.

### BACKGROUND OF THE INVENTION

1. Field of the Invention

The invention relates to an energy converting system, more particularly to an energy converting system capable of converting solar energy and wind energy into kinetic energy and filtering out impurities in air.

2. Description of the Related Art

Conventional wind turbines are classified into two categories, namely, horizontal-axis turbines and vertical-axis turbines. The efficiencies of vertical-axis turbines and horizontal-axis turbines are both limited by strength of wind power. Thus, conventional wind turbines suffer from the shortcoming that the supply of electric power is unable to meet the demand.

Moreover, since the horizontal-axis turbine station has a huge volume that occupies a relatively wide area, it is typically built in a place remote from a city, thus increasing transmission loss and building cost. Although the vertical-axis turbine has a smaller volume than that of the horizontal-axis turbine, such that it can be built in a place within or close to a city, efficiency of the former is lower than that of the latter.

Additionally, due to the rise of environmental consciousness, economizing on power consumption and reducing impurities such as CO₂ in air have also become important issues to be solved.

### SUMMARY OF THE INVENTION

Therefore, the object of the present invention is to provide an energy converting system that convert wind and solar energy into electricity with a relative low mechanical friction and, in the mean time, filter out CO₂ and impurities in air.

According to the present invention, an energy converting system is provided for converting wind energy into kinetic energy. The energy converting system comprises at least one energy converting mechanism that includes:

a fixed shaft unit including an upright fixed shaft;

a windmill device including a windmill unit disposed rotatably around the fixed shaft by means of magnetic levitation, the windmill unit including at least two first blades driven by the wind energy;

an air compartment disposed above the windmill device, rotation of the first blades of the windmill unit resulting in upward flow of compressed air into the solar-heated air compartment to thereby allow the air to be jetted out of the air compartment in such a manner to rotate the windmill device about the fixed shaft; and

a purifying device disposed in the air compartment or an air inlet of the energy converting mechanism for filtering out impurities in air before the air flows out of the air compartment.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of an energy converting mechanism of an energy converting system of a first preferred embodiment according to the present invention;

FIG. 2 is a partly sectional view of the energy converting mechanism of the first preferred embodiment;

FIG. 3 is a sectional view of the energy converting mechanism of the first preferred embodiment;

FIG. 4 is a fragmentary sectional view of the energy converting mechanism of the first preferred embodiment;

FIG. 5 is a schematic sectional view taken along line V-V in FIG. 2;

FIG. 6 is a schematic sectional view taken along line VI-VI in FIG. 2;

FIG. 7 is a schematic sectional view showing modified first blades;

FIG. 8 is a schematic bottom view illustrating a magnetic polarity arrangement between a magnetized upright shaft and a magnetized surrounding wall portion of the first preferred embodiment;

FIG. 9 is a top view showing a plurality of the energy converting mechanisms of the first preferred embodiment engaging each other;

FIG. 10 is a fragmentary sectional side view of the energy converting mechanisms of the first preferred embodiment;

FIG. 11 is a fragmentary sectional side view of an energy converting mechanism of a second preferred embodiment according to the present invention; and

FIG. 12 is a partly sectional view of an energy converting mechanism of a third preferred embodiment according to the present invention.

### DETAILED DESCRIPTION OF THE PREFERRED EMBODIMENTS

Before the present invention is described in greater detail, it should be noted that like elements are denoted by the same reference numerals throughout the disclosure.

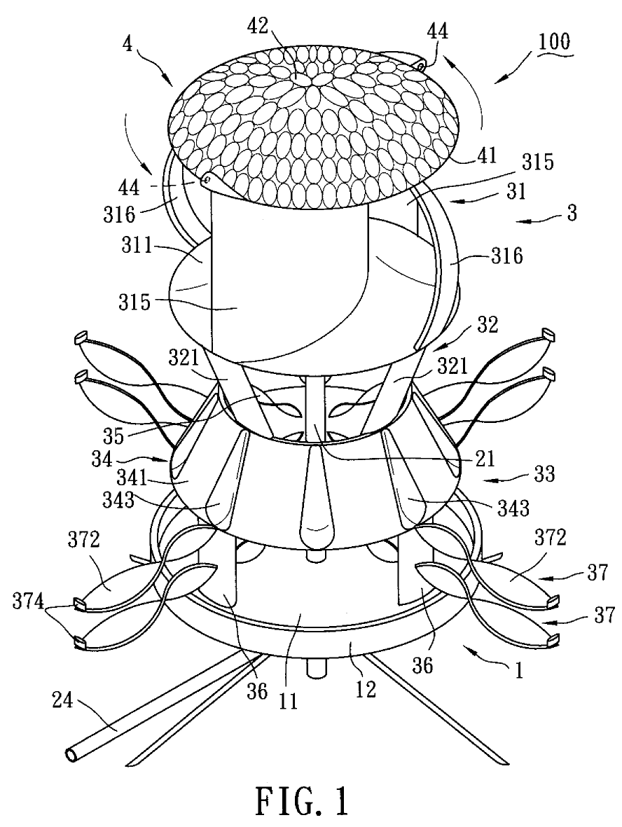

A first preferred embodiment of an energy converting system according to the present invention is shown in FIGS. 1 to 3. The energy converting system comprises an energy converting mechanism 100 including a base seat 1, a fixed shaft unit 2, a windmill device 3, a light-focusing device 4, a generator 5, and a purifying device 6.

The base seat 1 includes a main seat body 11, and a magnetized annular flange 12 extending upwardly from a periphery of the main seat body 11 and constituting a top end of the base seat 1.

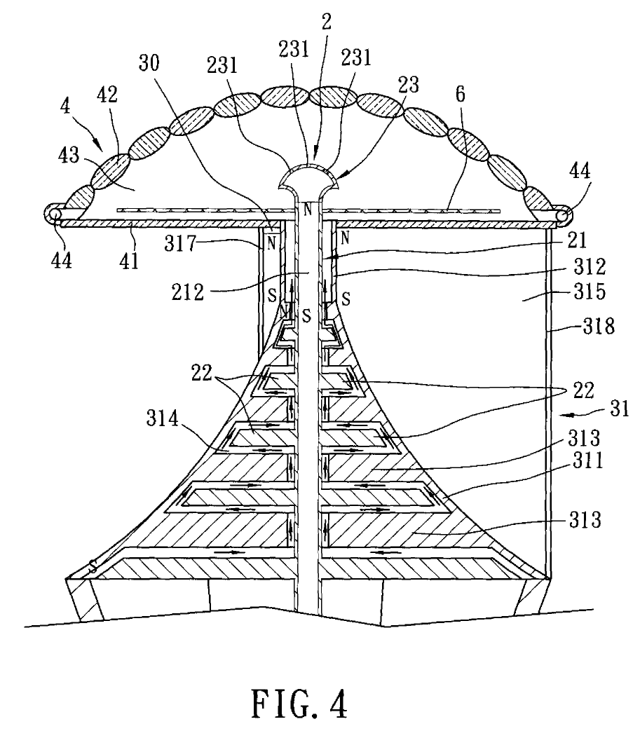

Further referring to FIG. 4, the fixed shaft unit 2 includes an upright fixed shaft 21, a plurality of fixed blades 22, a sprayer 23, and a delivery pipe 24.

The windmill device 3 includes a first windmill unit 31, a second windmill unit 32, and a third windmill unit 33. The first windmill unit 31 is disposed rotatably around the fixed shaft 21 and includes two first blades 315 driven by wind energy, a surrounding wall 311 that surrounds the fixed shaft 21 and that is configured as a tapered tube, and a plurality of rotating blades 313 that extend from the surrounding wall 311 toward the fixed shaft 21. The rotating blades 313 are spaced apart from each other and the fixed shaft 21.

The light-focusing device 4 is co-rotatable with the first windmill unit 31 and includes a light-focusing wall 42, a base wall 41, and two diametrically opposed jetting holes 44. The base wall 41 is disposed under and connected to the light-focusing wall 42 and cooperates with the light-focusing wall 42 to define a sealed air compartment 43 therebetween.

The surrounding wall 311 of the first windmill unit 31 has a diameter that reduces gradually toward the air compartment 43. A connecting wall 312 extends upwardly from a top end of the surrounding wall 311 to connect with the light-focusing device 4 and surrounds spacedly the fixed shaft 21. The connecting wall 312 cooperates with the surrounding wall 311 and the fixed shaft 21 to define an air passage 319 thereamong. The rotating blades 313 force air to flow upwardly from the air passage 314 in the surrounding wall 311 into the air compartment 43. The fixed blades 22 of the fixed shaft unit 2 extend radially and outwardly from the fixed shaft 21 toward the surrounding wall 311 and are spaced apart from each other and the surrounding wall 311. The fixed blades 22 and the rotating blades 313 are alternately arranged along a vertical direction. The air passage 314 is formed between the fixed blades 22 and the rotating blades 313 to allow air to flow into the air compartment 43 therethrough.

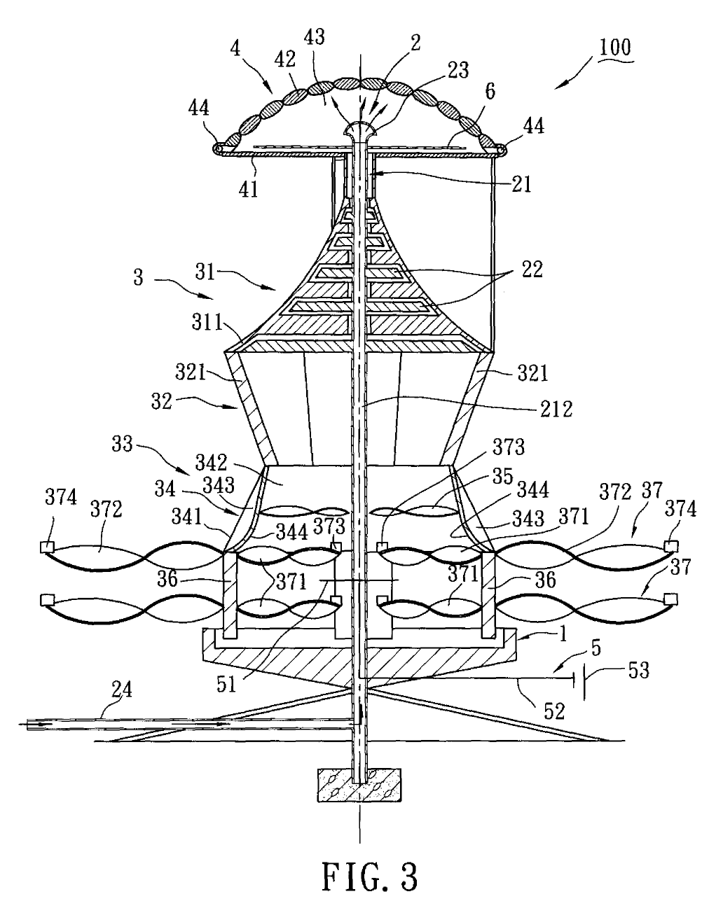

The fixed shaft 21 defines an axial passage 212 (see FIG. 3) in fluid communication with the air compartment 43. The delivery pipe 24 of the fixed shaft unit 2 is in fluid communication with the axial passage 212 in the fixed shaft 21 for supplying gas into the axial passage 212 and, thus, the air compartment 43. The sprayer 23 is disposed in the air compartment 93 and is connected to a top end of the fixed shaft 21. The sprayer 23 includes a plurality of openings 231 that permit the gas to flow from the axial passage 212 into the air compartment 43 therethrough.

Rotation of the first blades 315 of the first windmill unit 31 results in upward flow of air into the air compartment 43 to further pressurize the air in the air compartment 43 to thereby allow the air to be jetted out of the air compartment 43 in such a manner to rotate the light-focusing device 4 and, thus, the windmill device 3 about the fixed shaft 21. The jetting holes 44 are in fluid communication with the air compartment 43 and permit the pressurized air to jet out of the air compartment 43 therethrough in opposite directions.

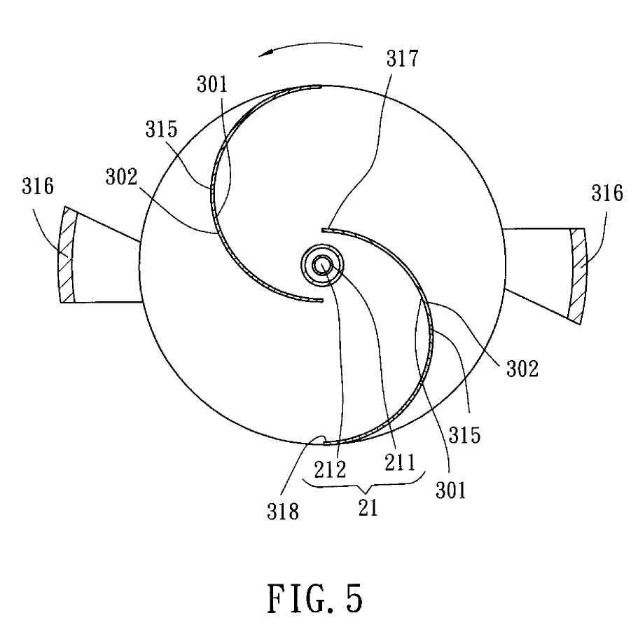

Further referring to FIG. 5, the first blades 315 are Savonius type blades. Each of the first blades 315 has an inner end 317 adjacent to and spaced apart from the fixed shaft 21, and an outer end 318 opposite to the inner end 317 and farther from the fixed shaft 21 than the inner end 317. Each of the first blades 315 has a concave side surface 301, and a convex side surface 302 opposite to the concave side surface 301.

The first windmill unit 31 further includes two auxiliary blades 316 disposed around the first blades 315 and each having a shape different from that of each of the first blades 315. In this embodiment, the auxiliary blades 316 are Darrieus type blades that extend parabolically and surround the first blades 315. Each of the auxiliary blades 316 has a top end connected to a bottom of the light-focusing device 4, and a lower end connected to a bottom of the surrounding wall 311. The efficiency of Darrieus type blades (auxiliary blades 316) is better than that of Savonius type blades (first blades 315). Thus, the auxiliary blades 316 can enhance a rotating power of the windmill device 3 and reduce air resistance of the convex side surfaces 302 of the first blades 315. It should be noted that the auxiliary blades 316 may be omitted in other embodiments of the invention.

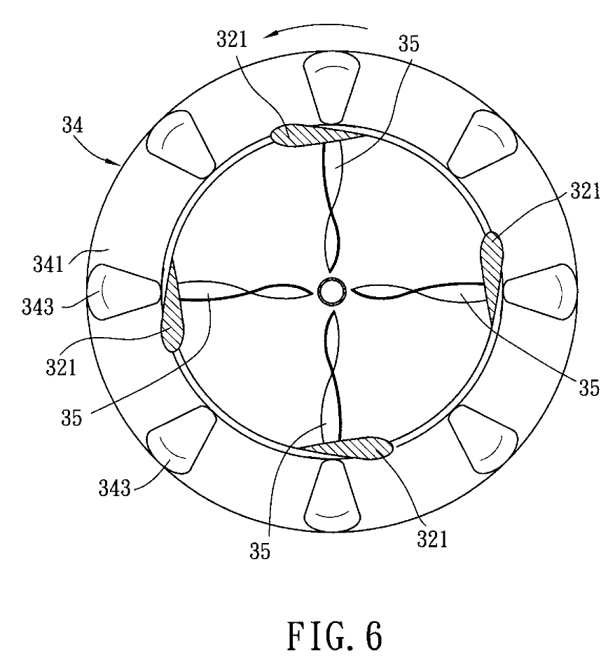

The second windmill unit 32 is disposed under and connected fixedly to the first windmill unit 31 for co-rotation therewith. Further referring to FIG. 6, the second windmill unit 32 includes four angularly equidistant second blades 321 disposed around the fixed shaft 21. In this embodiment, the second blades 321 are Darrieus type blades each having a cross-section that is shaped as a stretched water drop. The second blades 321 are inclined relative to the fixed shaft 21, and extend downwardly and inwardly from the first windmill unit 31. Each of the second blades 321 has a top end fixedly connected to a bottom end of the surrounding wall 311 of the first windmill unit 31, and a bottom end fixedly connected to a top end of the third windmill unit 33.

The third windmill unit 33 is disposed under the second windmill unit 32. The third windmill unit 33 includes a wind-guiding seat 34, four third blades 36 disposed under the wind-guiding seat 34, and four angularly equidistant enhancing blades 35. In this embodiment, the third blades 36 are Darrieus type blades. The wind-guiding seat 34 has a diameter that reduces gradually toward the second windmill unit 32. The wind-guiding seat 34 includes a downwardly diverging frustoconical surrounding wall 341 that defines an air-guiding space 342. The surrounding wall 341 has an outer surface formed with a plurality of guiding grooves 343, and an inner surface that confronts the fixed shaft 21 and that is formed with a plurality of convex surface portions 344 aligned with the guiding grooves 343, respectively. The enhancing blades 35 extend from the inner surface of the surrounding wall 341 toward the fixed shaft 21.

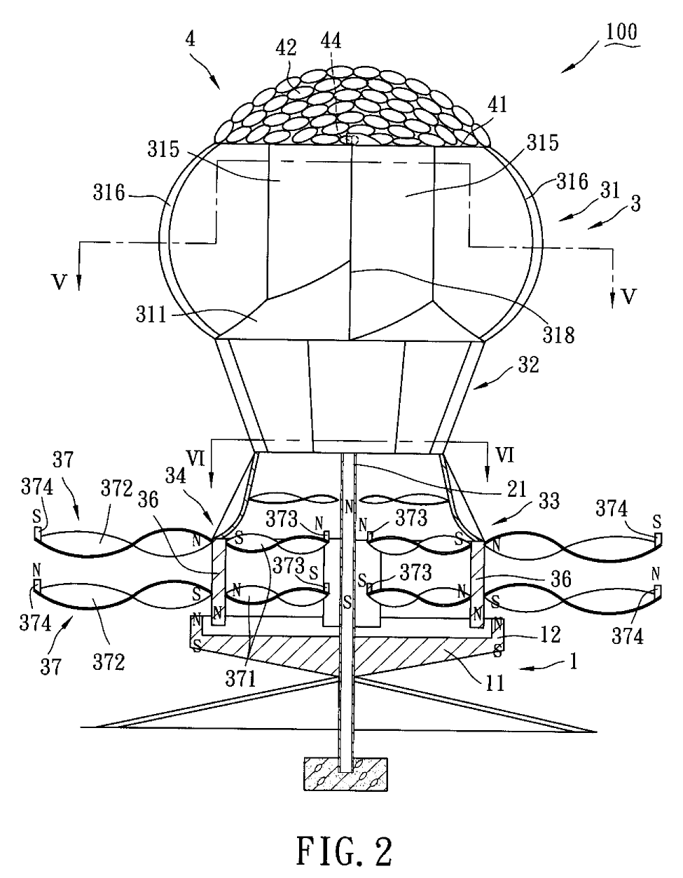

The third windmill unit 33 further includes two blade units 37 spaced-apart along the vertical direction. Each of the blade units 37 includes four inner blades 371 each extending from a respective one of the third blades 36 toward the fixed shaft 21 and adjacent to and spaced apart from the fixed shaft 21, and four outer blades 372 each extending from the respective one of the third blades 36 away from the fixed shaft 21 (see FIG. 2). Each of the inner blades 371 and the outer blades 372 is configured as a propeller blade in this embodiment.

Referring back to FIG. 3, a generator 5 is connected to the windmill device 3 for converting rotational kinetic energy of the windmill device 3 into electric power. The generator 5 includes a coil 51 that is disposed between the blade units 37 and that generates induced current as a result of rotation of the blade units 37 of the third windmill unit 33, a conductive wire 52 electrically connected to the coil 51, and a rechargeable battery 53 electrically connected to the conductive wire 52.

Referring back to FIG. 2, the magnetized annular flange 12 has a top end having a first magnetic polarity, and a bottom end having a second magnetic polarity. In this embodiment, the first magnetic polarity is (N) pole, and the second magnetic polarity is (S) pole, as indicated by (N), (S) respectively in FIGS. 2, 4, and 8.

A bottom end of each of the third blades 36 has a first magnetic polarity (N). As such, a magnetic repulsive force is generated between the top end of the magnetized annular flange 12 of the base seat 1 and the bottom end of each of the third blades 36 so as to allow the third windmill unit 34 to levitate above the base seat 1. Therefore, when the third windmill unit 34 rotates relative to the base seat 1, a friction force between the third windmill unit 34 and the base seat 1 is avoided.

The upper blade unit 37 has the first magnetic polarity (N) at the inner magnetized portions 373, and the second magnetic polarity (S) at the outer magnetized portions 374. The lower blade unit 37 has the second magnetic polarity (S) at the inner magnetized portions 373, and the first magnetic polarity (N) at the outer magnetized potions 374.

The fixed shaft 21 has a magnetic polarity the same as that of the inner magnetized portions 373 of the inner blades 371 at a portion thereof adjacent to the ends of the inner blades 371, i.e., the fixed shaft 21 has the first magnetic polarity (N) at an upper portion thereof and the second magnetic polarity (S) at a lower portion thereof. Magnetic repulsive forces are generated between the inner blades 371 and the fixed shaft 21, thus avoiding a friction force and reducing vibration and noise.

Referring back to FIG. 4, the inner end 317 of each of the first blades 315 has the first magnetic polarity (N) at a top end thereof, and the second magnetic polarity (S) at a bottom end thereof. The fixed shaft 21 has two portions that are adjacent respectively to the inner ends 317 of the first blades 315 and that are of opposite magnetic polarities, such that magnetic repulsive forces are generated between the fixed shaft 21 and the inner ends 317 of the first blades 315.

Referring to FIGS. 1, 3, and 4, the light-focusing wall 42 of the light-focusing device 4 is made of a light-transmissive material and is composed of a plurality of interconnected light-focusing lenses that are capable of focusing sunlight into the air compartment to thereby heat and pressurize air in the air compartment 43. The jetting holes 44 in the light-focusing device 4 permit the pressurized air to be jetted therefrom in opposite directions so that a rotational kinetic energy is generated and a force couple effect is created to rotate the light-focusing device 4 and the windmill device 3. Rotation of the rotating blades 313 results in upward flow of air into the air compartment 43 via the air passage 314. When the air flows in the air passage 314, since the diameter of the surrounding wall 311 is reduced gradually and upwardly, the air in the air passage 314 is pressurized. The air flowing into the air compartment 43 is further heated up and pressurized and then jetted out of the air compartment 43 through the jetting holes 44 so as to rotate the light-focusing device 4 and, thus, the windmill device 3 about the fixed shaft 21.

That is to say, a positive feedback loop is formed between the light-focusing device 4 and the windmill device 3. Air is heated and pressurized by the light-focusing device 4 to thereby jet out of the air compartment 43 so as to drive the light-focusing device 4 and the windmill device 3 to rotate. After the windmill device 3 rotates, rotation of the rotating blades 313 results in upward flow of air into the air compartment 43, thus further facilitating flow of the air out of the air compartment 43.

It should be noted that, while the fixed blades 22 and the rotating blades 313 are used in this embodiment, it is understood that this invention is not limited to the configuration of this embodiment as long as upward flow of air into the air compartment 43 is achieved.

When the third windmill unit 33 rotates, the blade units 37 are rotated about the fixed shaft 21. The outer blades 372 of the blade units 37 force air to flow into the second windmill unit 32. At the same time, rotation of the inner blades 371 results in upward flow of air into the wind-guiding seat 34. The presence of the outer blades 372 facilitates air inflow into the second windmill unit 32 and rotation of the first windmill unit 31. With the aid of the convex surface portions 344 and the enhancing blades 35 of the wind-guiding seat 34, the speed of air flowing into the second windmill unit 32 can be increased.

The magnetized outer blades 372 of the blade units 37 extend horizontally and outwardly, thus improving stability during rotation of the windmill device 3. The coil 51 generates induced current as a result of rotation of the blade units 37 of the third windmill unit 33. The conductive wire 52 is electrically connected to the coil 51, and permits the induced current to flow from the coil 51 into the rechargeable battery 53 threrethrough.

It should be noted that the generator 5 can be replaced with a pumping station or a water-piping device in other embodiments. Additionally, even if the air compartment 43 is not sealed, air in the air compartment 43 can be heated up.

By virtue of the light-focusing device 4, as long as the weather is sunny or windy, the windmill device 3 can be rotated.

The purifying device 6 is disposed in the air compartment 43 and includes a filtering material in a form of granular particles or membranes made of NaOH and Ca(OH)₂ for filtering out impurities such as CO₂ in air before the air flows out of the air compartment 43. In this embodiment, the purifying device 6 is disposed directly above and adjacent to a top end of the air passage 314. It should be noted that the purifying device 6 may not be disposed in the air compartment 43, e.g., the purifying device 6 may be disposed in the delivery pipe 24 adjacent to an air inlet 241 thereof.

The delivery pipe 24 is in fluid communication with the axial passage 212 of the fixed shaft 21. Industrial exhaust gas as well as steam and other gas generated by other alternative sources of energy such as terrestrial heat, maybe supplied into the axial passage 212 through the delivery pipe 24 to drive the light-focusing device 4 to rotate, such that the windmill device 3 can be rotated when the weather is neither sunny nor windy. In fact, the rotation of the first windmill unit 31 results in upward flow of air into the air compartment 43, such that the second windmill unit 32 and the third windmill unit 33 can be omitted.

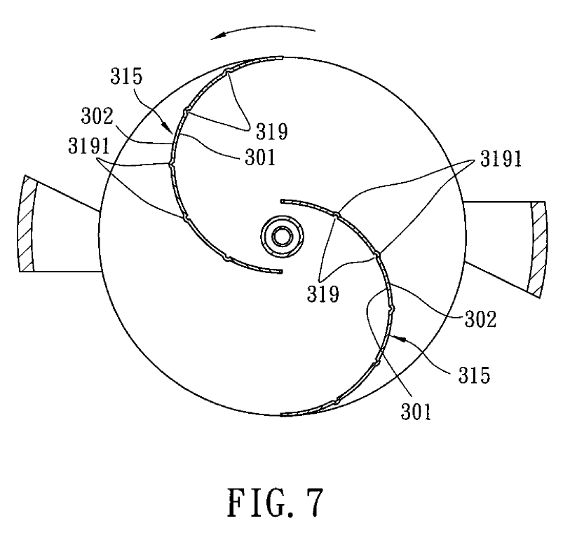

Referring to FIG. 7, there is shown a modification of the first blades 315. Each of the modified first blades 315 differs from that shown in FIG. 5 in that each of the concave side surfaces 301 of the first blades 315 is formed with a plurality of concave surface portions 319, and each of the convex side surfaces 302 of the first blades 315 is formed with a plurality of convex surface portions 3191 aligned respectively with the concave surface portions 319. Due to the presence of the concave surface portions 319, a contact area between wind and the concave side surfaces 301 is increased. A plurality of concave surface portions may also be configured on all of the blades in the present invention for the same purpose as those provided in a golf ball.

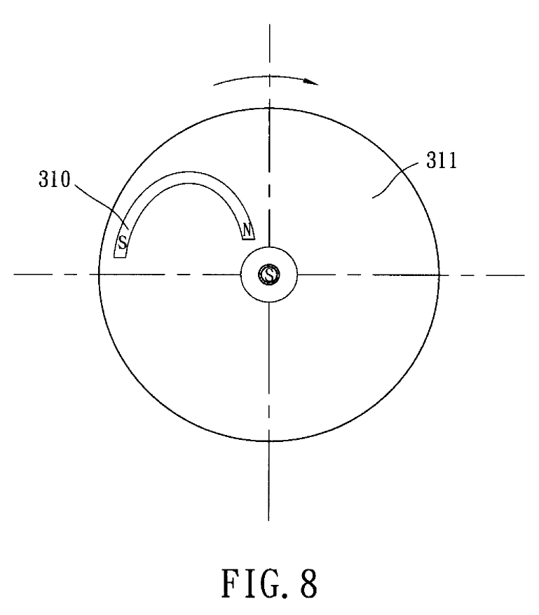

Referring to FIGS. 4 and 8, each quarter of the surrounding wall 311 of the first windmill unit 31 has one arch magnetized area 310. The magnetized area 310 has a top portion of the first magnetic polarity (N) and a bottom portion of the second magnetic polarity (S). The fixed shaft 21 has the second magnetic polarity (S) at a position adjacent to the top portion of the magnetized area 310.

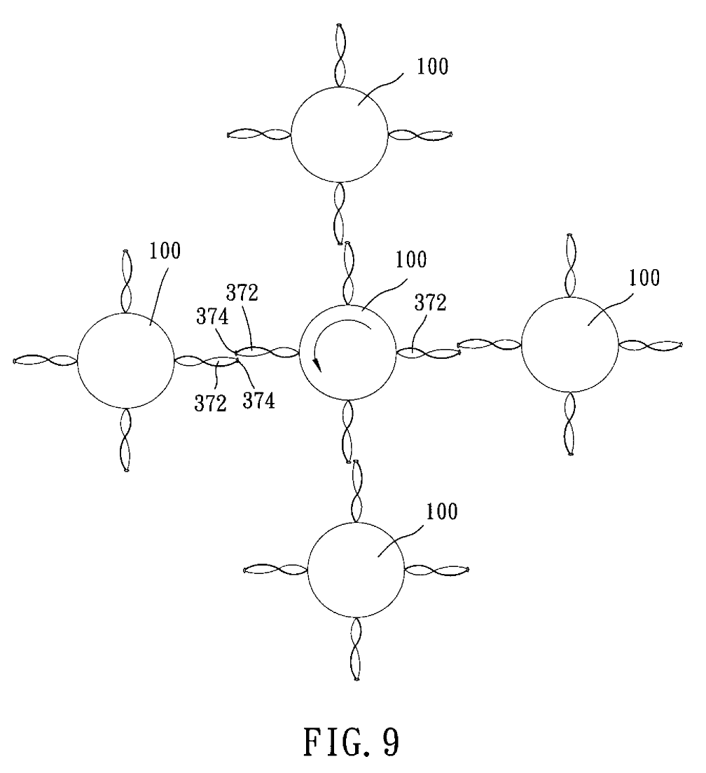

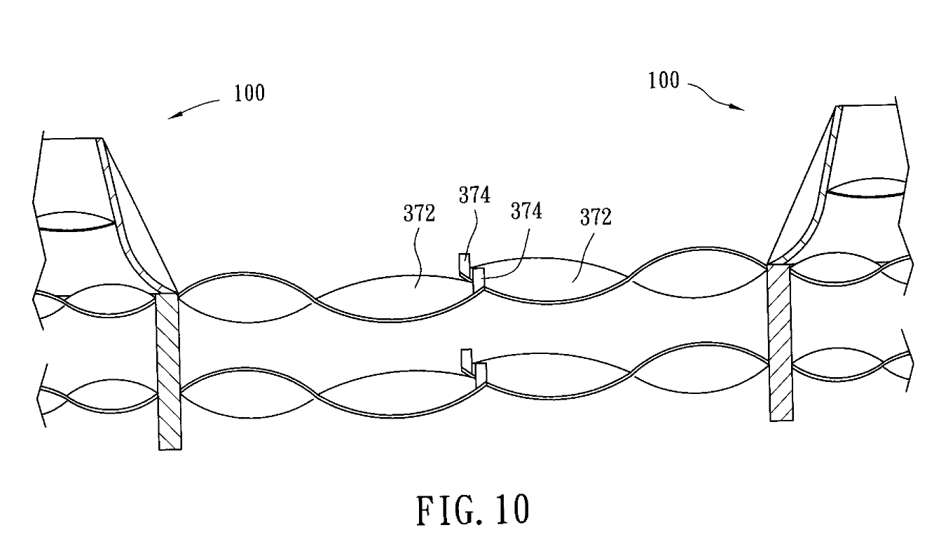

The invention is a vertical-axis wind turbine that has a smaller volume than that of a horizontal-axis turbine. As shown in FIG. 9, a plurality of the energy converting mechanisms 100 may be interconnected. Each circle in FIG. 9 together with four outer blades 372 represents one energy converting mechanism 100. Further referring to FIG. 10, the energy converting mechanisms 100 are arranged such that the outer magnetized portions 374 of the outer blades 372 of each of the energy converting mechanisms 100 are movable in a counterclockwise direction to push and rotate the outer magnetized portions 374 of any adjacent energy converting mechanism 100. As a consequence, once any one of the energy converting mechanisms 100 starts to rotate, the remaining energy converting mechanisms 100 are driven to rotate because of the magnetic repulsive force between each adjacent pair of the outer magnetized portions 374.

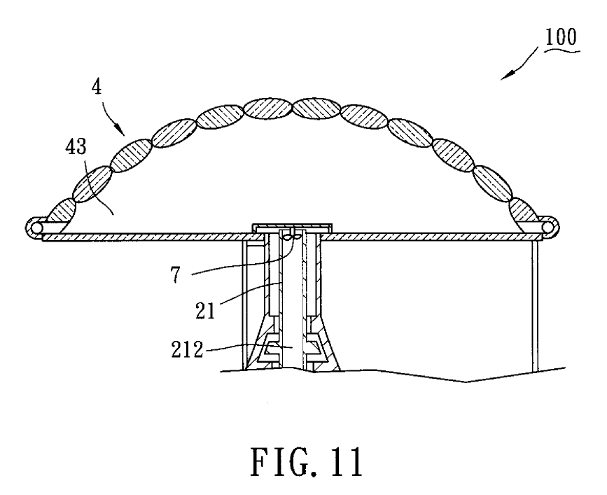

As shown in FIG. 11, a second preferred embodiment of the energy converting mechanism 100 according to the present invention has a structure similar to that of the first embodiment. The main difference between this embodiment and the first embodiment resides in the following. The energy converting mechanism 100 further comprises a rotating fan 7 disposed rotatably in the axial passage 212 and connected fixedly to the light-focusing device 4 so that the rotating fan 7 is co-rotatable with the light-focusing device 4 relative to the fixed shaft 21 to thereby force the gas to flow from the axial passage 212 into the air compartment 43. As such, the gas can flow into the air compartment 43 at a high speed.

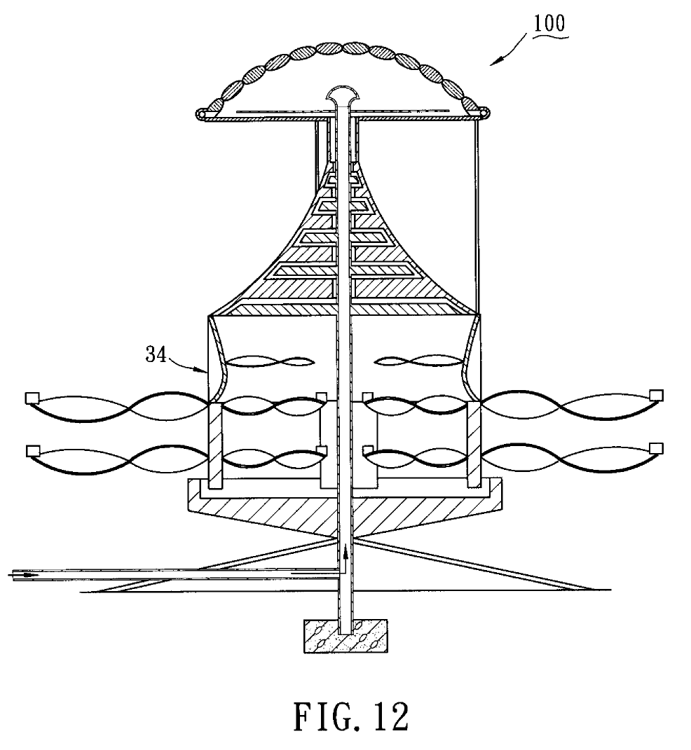

As shown in FIG. 12, a third preferred embodiment of the energy converting mechanism 100 according to the present invention has a structure similar to that of the first embodiment. The main difference between this embodiment and the first embodiment resides in the following. In this embodiment, the second windmill unit 32 is omitted (see FIG. 3), and the wind-guiding seat 39 of the third windmill unit 33 is configured as a cylinder. The third preferred embodiment has the same advantages as those of the first preferred embodiment.

To sum up, the energy converting system of the present invention converts solar energy and wind energy into kinetic energy, cooperates with other alternative energy sources such as terrestrial heat, and employs magnetic repulsive force to drive the energy converting system. Moreover, the configuration of the present invention may be modified for use in generation of electricity, ventilation, dissipation of heat, and filtration of air and gas.

While the invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An energy converting system for converting wind energy into kinetic energy, said energy converting system comprising at least one energy converting mechanism that includes:
a fixed shaft unit including an upright fixed shaft;
a windmill device including a windmill unit disposed rotatably around said fixed shaft, said windmill unit including at least two first blades driven by the wind energy;
an air compartment disposed above said windmill device, rotation of said first blades of said windmill unit resulting in upward flow of air into said air compartment to thereby allow the air to be jetted out of said air compartment in such a manner to rotate said windmill device about said fixed shaft; and
a purifying device disposed in said air compartment for filtering out impurities in air before the air flows out of said air compartment.

2. The energy converting system as claimed in claim 1, wherein said purifying device includes a filtering material that filters out carbon dioxide and impurities in said air compartment.

3. The energy converting system as claimed in claim 1 further comprising a light-focusing device co-rotatable with said windmill unit and including a light-focusing wall disposed above and defining said air compartment, said light-focusing wall being made of a material and having a structure so as to focus sunlight into said air compartment.

4. The energy converting system as claimed in claim 3, wherein said light-focusing wall is composed of at least one light-focusing lens.

5. The energy converting system as claimed in claim 3, said light-focusing device further includes a base wall disposed under and connected to said light-focusing wall and cooperating with said light-focusing wall to define said air compartment therebetween, and two diametrically opposed jetting holes in fluid communication with said air compartment and permitting air to jet out of said air compartment therethrough in opposite directions.

6. The energy converting system as claimed in claim 1, wherein said windmill unit further includes a surrounding wall that surrounds said fixed shaft, and at least one rotating blade that extends from said surrounding wall toward said fixed shaft for forcing air to flow upwardly from said air passage into said air compartment, and that cooperates with said fixed shaft to define an air passage thereamong.

7. The energy converting system as claimed in claim 1, wherein said windmill unit further includes two auxiliary blades disposed around said first blades, each of said auxiliary blades having a shape different from that of each of said first blades.

8. The energy converting system as claimed in claim 7, wherein said first blades are Savonius type blades, and said auxiliary blades are Darrieus type blades.

9. The energy converting system as claimed in claim 1, wherein each of said first blades has a concave side surface formed with a plurality of concave surface portions, and a convex side surface opposite to said concave side surface and formed with a plurality of convex surface portions aligned respectively with said concave surface portions.

10. The energy converting system as claimed in claim 1, wherein said fixed shaft has an annular shaft wall defining an axial passage that is in fluid communication with said air compartment, said fixed shaft unit further including a delivery pipe that is in fluid communication with said axial passage in said fixed shaft.

11. energy converting system as claimed in claim 10, wherein said fixed shaft unit further includes a sprayer disposed in said air compartment and connected to a top end of said fixed shaft, said sprayer including at least one opening that permits the gas to flow from said axial passage into said air compartment therethrough.

12. The energy converting system as claimed in claim 1, wherein said at least one energy converting mechanism further comprises a generator connected to said windmill device for converting rotational kinetic energy of said windmill device into electric power.

13. The energy converting system as claimed in claim 1, wherein each of said first blades has an inner end adjacent to and spaced apart from said fixed shaft, and an outer end opposite to said inner end and farther from said fixed shaft than said inner end, said inner end of each of said first blades having spaced-apart first and second ends that have opposite magnetic polarities, said fixed shaft having two portions that are adjacent respectively to said inner ends of said first blades, each of said portions of said fixed shaft having spaced-apart first and second sections that have opposite magnetic polarities such that a magnetic repulsive force is generated between said fixed shaft and said inner ends of said first blades.

14. The energy converting system as claimed in claim 1, wherein said energy converting mechanism further includes at least two outer blades each extending away from said fixed shaft and being configured to further facilitate rotation of said windmill device about said fixed shaft.

15. The energy converting system as claimed in claim 14, said energy converting system comprising a plurality of said energy converting mechanisms, each of said outer blades has an outer magnetized portion that projects upwardly from an end thereof distal from said fixed shaft of a respective one of said energy converting mechanisms, said outer blades of said energy converting mechanisms being positioned such that, when said windmill device of any one of said energy converting mechanisms starts to rotate, the remaining energy converting mechanisms are driven by the one of said energy converting mechanisms to rotate.
